(19) United States
(12) Patent Application Publication
(10) Pub. No.: US 2008/0181626 A1
(43) Pub. Date: Jul. 31, 2008

(54) PRINTER MANAGEMENT APPARATUS AND PRINTER MANAGEMENT METHOD

(75) Inventors: Akihiro Mizutani, Tokyo (JP); Kazuhiro Ogura, Kanagawa-ken (JP); Shinji Makishima, Tokyo (JP); Toshihiro Ida, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/668,163

(22) Filed: Jan. 29, 2007

(51) Int. Cl. G03G 15/00

(52) U.S. Cl. 399/24

(57) ABSTRACT

To allow a user to efficiently select a printer and a printer drive for the printer by providing information on a selection state of printers and printer drives for the printers of users around the user when the user selects a printer and a printer driver for the printer.

A printer management apparatus includes a state-of-use managing unit that manages, on the basis of a history of communication with a terminal apparatus, predetermined information concerning a state of use of a printer by the terminal apparatus and a state-of-use displaying unit that transmits, in response to a printer device detection signal received from the terminal apparatus, the predetermined information concerning the state of use of the printer managed by the state-of-use managing unit to the terminal apparatus, which transmits the printer device detection signal, and causes the terminal apparatus to display the predetermined information.

### BACKGROUND OF THE INVENTION

1. Field of the Invention

The present invention relates to a printer management apparatus and a printer management method.

2. Description of the Related Art

Conventionally, when plural image forming apparatuses are installed in different plural locations, a user selects an image forming apparatus that is capable of executing an output satisfying output conditions required by the user and a physical position of which is closest to the user. In this case, the user has to designate an image forming apparatus as an output destination out of the plural image forming apparatuses taking into account output conditions and a physical position of the output destination, leading to work troublesome for the user. As a solution for such a problem, there is an example in which it is possible to, even if a user does not designate an output destination, automatically select an image forming apparatus, which is physically located at a short distance from the user and can perform an output desired by the user, and send an output request to the image forming apparatus (JP-A-10-333845).

As measures for solving such work troublesome for the user in designating an image forming apparatus as an output destination, as described in the example cited above, information on a positional relation between plural information processing apparatuses as request sources of print outputs and plural printers as output destinations is stored. However, this is a technique for selecting an image forming apparatus physically close to the user. An image forming apparatus optimum for the user is not always selected.

### SUMMARY OF THE INVENTION

It is an object of an embodiment of the invention to provide a printer management apparatus and a printer management method that allow a user to efficiently select a printer and a printer drive for the printer by providing information on a selection state of printers and printer drives for the printers of users around the user when the user selects a printer and a printer drive for the printer.

In order to solve the problems, a printer management apparatus according to the invention includes a state-of-use managing unit that manages, on the basis of a history of communication with a terminal apparatus, predetermined information concerning a state of use of a printer by the terminal apparatus and a state-of-use displaying unit that transmits, in response to a printer device detection signal received from the terminal apparatus, the predetermined information concerning the state of use of the printer managed by the state-of-use managing unit to the terminal apparatus, which transmits the printer device detection signal, and causes the terminal apparatus to display the predetermined information.

A printer management apparatus according to the invention includes state-of-use managing means for managing, on the basis of a history of communication with a terminal apparatus, predetermined information concerning a state of use of a printer by the terminal apparatus and state-of-use displaying means for transmitting, in response to a printer device detection signal received from the terminal apparatus, the predetermined information concerning the state of use of the printer managed by the state-of-use managing means to the terminal apparatus, which transmits the printer device detection signal, and causing the terminal apparatus to display the predetermined information.

A printer management method according to the invention includes a step of managing, on the basis of a history of communication with a terminal apparatus, predetermined information concerning a state of use of a printer by the terminal apparatus in a state-of-use managing unit by databasing the predetermined information, a step of receiving a printer device detection signal of multicast transmitted from the terminal apparatus, and a step of a state-of-use displaying unit transmitting, in response to a printer device detection signal received, the predetermined information concerning the state of use of the printer managed by the state-of-use managing unit to the terminal apparatus, which transmits the printer device detection signal, and causing the terminal apparatus to display the predetermined information.

### DESCRIPTION OF THE DRAWINGS

FIG. 1 is a diagram of a network including a multifunction peripheral, which is provided with a printer management apparatus according to an embodiment of the invention, and a client PC;

FIG. 2 is an explanatory diagram showing an example of a structure of an internal database in which contents of SOAP communication performed by the printer management apparatus according to the embodiment with the client PC are stored;

FIG. 3 is a layout diagram showing an example of an arrangement structure of client PCs and printers in an office to which the printer management apparatus and a printer management method according to the embodiment are applied;

FIG. 4 is a network diagram showing an example of a network structure in the office of the client PCs and the printers in the arrangement structure shown in FIG. 3;

FIG. 5 is a flowchart showing operations in storing information in the internal database when a printer is searched by a client PC in the printer management apparatus according to the embodiment;

FIG. 6 is an explanatory diagram showing a structure of an internal database indicating a search state for a printer P1 and an installation state of a printer driver for the printer P1;

FIG. 7 is an explanatory diagram showing a structure of the database indicating a search state for a printer P2 and an installation state of a printer driver for the printer P2;

FIG. 8 is an explanatory diagram showing a structure of the database indicating a search state for a printer P3 and an installation state of a printer driver for the printer P3;

FIG. 9 is an explanatory diagram of contents presented to a user when selection information concerning printers found is sorted with the number of times of installation of printer drivers for the printers;

FIG. 10 is an explanatory diagram of contents presented to the user when the selection information concerning the printers found is sorted with a last printing date;

FIG. 11 is an explanatory diagram showing a structure of the internal database for the printer P1 after the printer driver for the printer P3 is installed by a new user;

FIG. 12 is an explanatory diagram showing a structure of the internal database for the printer P2 after the printer driver for the printer P3 is installed by a new user;

FIG. 13 is an explanatory diagram showing a structure of the internal database for the printer P3 after the printer driver for the printer P3 is installed by a new user;

FIG. 14 is a flowchart showing an operation for presenting an appropriate setting for reestablishment of a printer use environment in a printer management apparatus according to another embodiment; and

FIG. 15 is a flowchart showing an operation in referring to an installation state of a printer driver of another user on a network in a printer management apparatus according to still another embodiment.

### DESCRIPTION OF THE EMBODIMENTS

Embodiments of the invention will be hereinafter explained with reference to the drawings.

FIG. 1 is a diagram of a network including a multifunction peripheral, which is provided with a printer management apparatus according to the embodiment, and a client PC.

A multifunction peripheral (hereinafter referred to as MFP) 1 includes a printing apparatus 11, a scanning apparatus 12, a control panel 13, a database 14, a control unit 16, and a system bus 17. This MFP 1 is connected to a client PC 21 via a system bus 17.

The printing apparatus 11 is a printer apparatus that has a care-of printing function. A scanning apparatus 12 is an apparatus that optically scans the surface of a set original with, for example, a CCD line sensor and detects a picture inscribed on the surface of the original as image information. The control panel 13 is, for example, a large liquid crystal screen provided in the printing apparatus 11. The database 14 stores contents of SOAP (Simple Object Access Protocol) communication performed by this MFP 1 with the client PC 21 via the system bus 17. The control unit 16 is connected to the printing apparatus 11, the scanning apparatus 12, the control panel 13, and the database 14 via the system bus 17 and performs control of these functional units. The client PC 21 includes a personal computer, a PDA, and a cellular phone. The control unit 16 constitutes a state-of-use managing unit (state-of-use managing means), a state-of-use displaying unit (state-of-use displaying means), and a specific-user state-of-use searching unit (specific-user state-of-use searching means) of the invention.

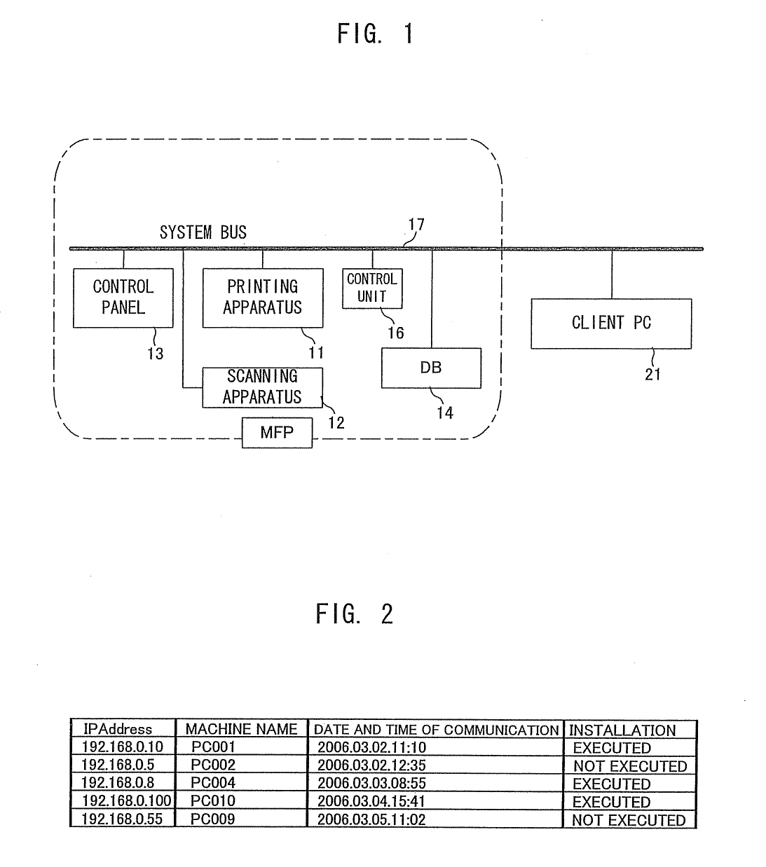

FIG. 2 is an explanatory diagram showing an example of a structure of an internal database 14 in which contents transmitted and received by the MFP 1 to and from plural client PCs including the client PC 21 according to the SOAP communication are stored. In the example of the structure of the database shown in FIG. 2, the contents transmitted and received according to the SOAP communication including IP addresses of the client PCs with which the MFP 1 performed the SOAP communication, machine names of the client PCs, date and times of communication, and indications on whether a printer driver for the MFP 1 is finally installed on the side of the client PCs are stored as predetermined information concerning states of use of a printer by the client PCs based on a history of communication with the client PCs.

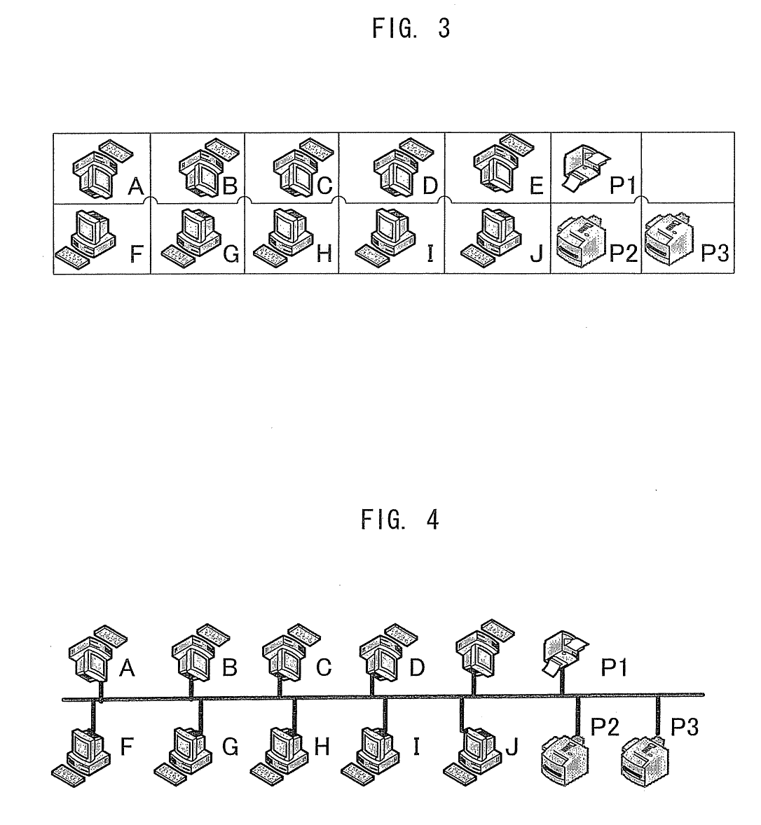

FIG. 3 is a layout diagram showing an example of an arrangement structure of client PCs and printers in an office to which the printer management apparatus and a printer management method according to this embodiment are applied. Reference signs P1, P2, and P3 denote various printers including MFPs provided with printer management apparatuses. Reference signs A, B, C, D, E, F, G, H, I, and J denote client PCs.

FIG. 4 is a network diagram of the printers and the client PCs in the arrangement structure shown in FIG. 3.

The printers and the client PCs are arranged in the office in the arrangement structure shown in FIG. 3. The printers and the client PCs are connected to a network in the office in the network structure shown in FIG. 4.

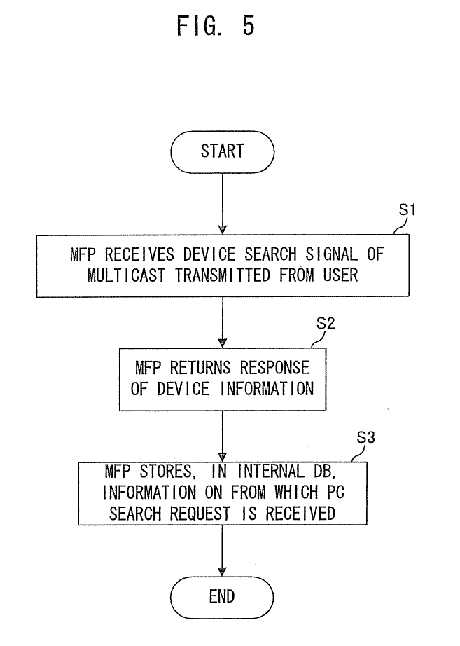

Processing for storing information in internal databases by printer management apparatuses provided in the printers P1, P2, and P3 including MFPs shown in FIG. 3, respectively, will be explained. FIG. 5 is a flowchart showing processing for storing information in the internal database 14 by the printer management apparatus of the MFP 1 shown in FIG. 1. In step S1, the MFP 1 receives search signals for the printers P1, P2, and P3 of multicast simultaneously transmitted from the client PCs as users to the printers P1, P2, and P3. In the following step S2, the MFP 1 returns device information concerning the printers P1, P2, and P3 to the client PCs, which transmit the search signals. Step S2 constitutes a state-of-use displaying unit and state-of-use displaying means and a state-of-use displaying step in the embodiment of the invention. Moreover, in the next step S3, the MFP 1 stores, in the internal database 14, printing information including information peculiar to the client PCs, which request searches, including IP addresses and machine names of the client PCs, which transmit search signals, date and times the printers are searched for, indications on whether printer drivers are finally installed, and printing modes such as color or monochrome of printing executed when the printer drivers are installed. Step S3 constitutes a state-of-use managing unit and state-of-use managing means and a state-of-use managing step in the embodiment of the invention.

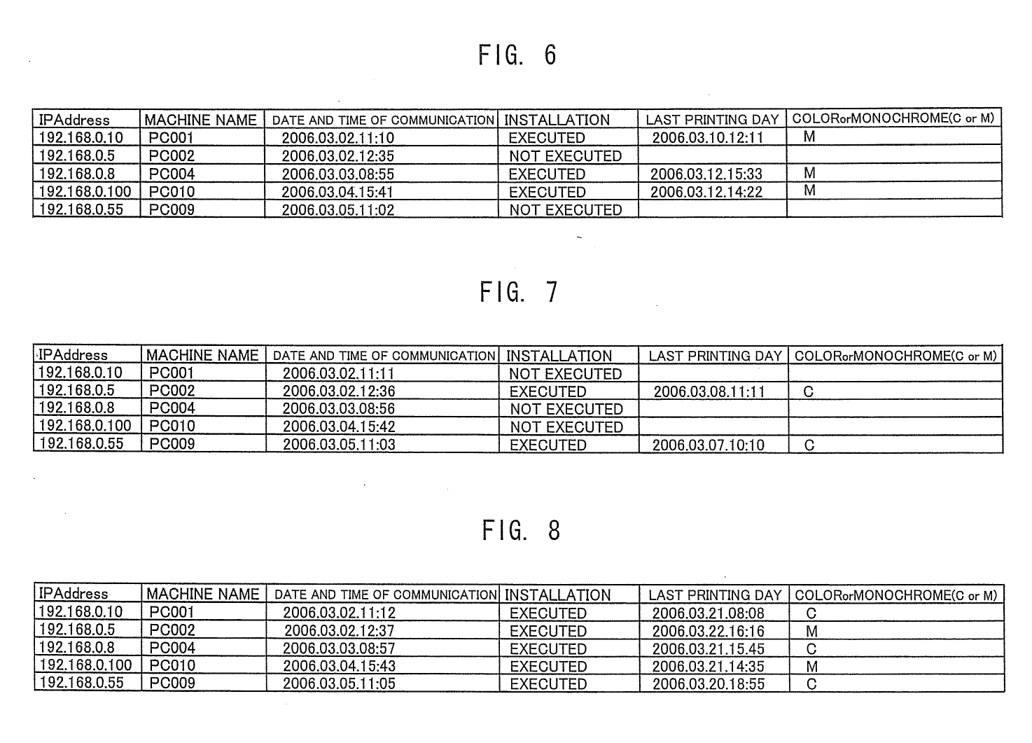

FIG. 6 shows an example of printing information stored in the internal database 14 shown in FIG. 1 including peculiar information such as IP addresses and machine names of client PCs, which request searches for the printer P1, date and times the printer P1 is searched for, indications on whether a printer driver is finally installed, and printing modes such as color or monochrome of printing executed when the printer driver is installed. FIG. 7 shows an example of printing information also stored in the internal database 14 including peculiar information such as IP addresses and machine names of client PCs, which request searches for the printer P2, date and times the printer P2 is searched for, indications on whether a printer driver is finally installed, and printing modes of printing executed when the printer driver is installed. FIG. 8 shows an example of printing information also stored in the internal database 14 including peculiar information such as IP addresses and machine names of client PCs, which request searches for the printer P3, date and times the printer P3 is searched for, indications on whether a printer driver is finally installed, and printing modes such as color printing or monochrome printing executed when the printer driver is installed.

Operations at the time when a new user makes connection to this network and installs printer drivers will be explained.

For example, it is assumed that the new user becomes capable of using a client PC with a machine name PC011 and an IP address: 192.168.0.111 on the network on Mar. 23, 2006. In this case, concerning installation of printer drivers, conventionally, the printers P1, P2, and P3 are only displayed on the client PC of the new user as a search result.

On the other hand, in this embodiment, contents of the internal database 14 concerning the printers P1, P2, and P3 shown in FIGS. 6, 7, and 8 are transmitted to the client PC of the new user. This client PC additionally acquires the contents of the internal database 14 concerning these printers P1, P2, and P3. As a result, the new user can easily obtain information on printer drivers for which printer apparatuses users around the new user install and which printer apparatuses the users use to perform printing under a network environment to which the client PC is connected.

In the client PC of the new user, sort programs for performing sort using, as keys, the contents of the internal database 14 concerning these printers P1, P2, and P3, for example, the numbers of times of execution of installation for the printer drivers for the respective printer apparatuses and states of use including last printing days in the respective printer apparatuses are stored. According to these sort programs, the contents of the internal database 14 concerning the printers P1, P2, and P3 acquired are sorted and present to the new user on the basis of the keys such as the number of times of installation and the last printing days.

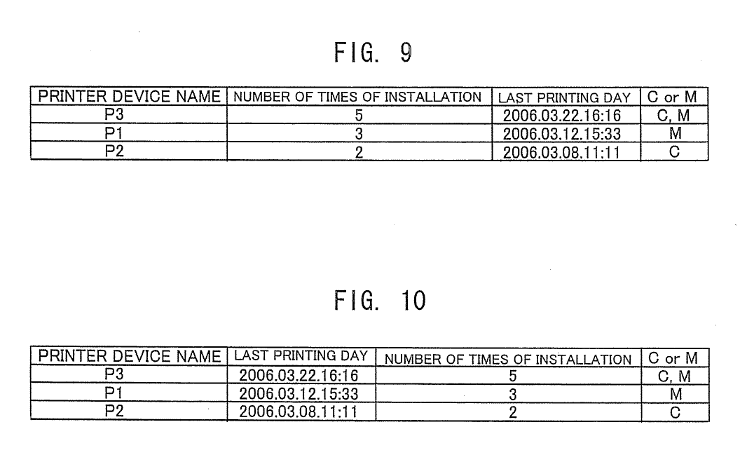

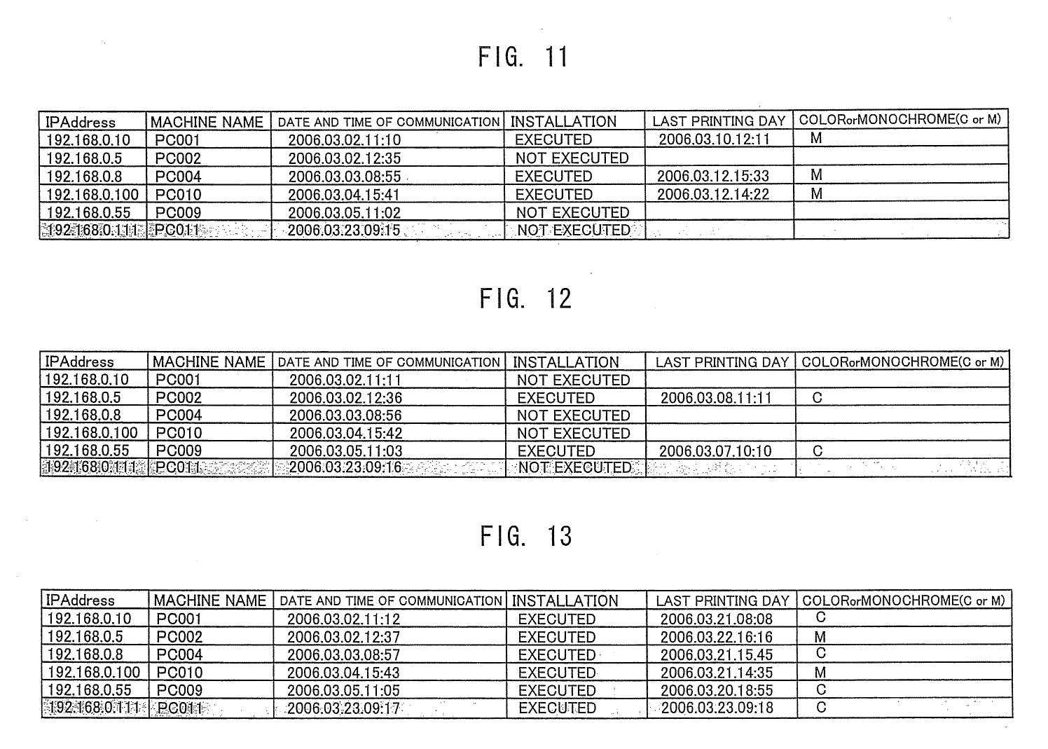

FIG. 9 shows results obtained by searching through the contents of the internal database 14 concerning the printers P1, P2, and P3 and sorting the search results with the number of times of installation as a key. In an example shown in FIG. 9, other than printer apparatus names, the numbers of times of installation, and last printing days, printing modes such as color printing or monochrome printing executed when printer drivers are installed are presented to the new user as information on selection of the respective printer apparatuses. FIG. 10 is shows results obtained by performing sort with the last printing day as a key in the same manner. In an example shown in FIG. 10, other than printer apparatus names and last printing days, the numbers of times of installation and printing modes such as color printing or monochrome printing executed when printer drivers are installed are presented to the new user as information on selection of the respective printer apparatuses.

The new user is capable of easily learning from the results of sort performed with the number of times of installation as a key shown FIG. 9 that a printer apparatus having a highest frequency of use under the network environment, to which the new user makes connection, is the printer P1. Further, the new user is capable of easily learning from the results of sort performed with the last printing day as a key shown in FIG. 10 that a printer apparatus with which printing was performed most lately under the network environment, to which the new user makes connection, is the printer P3.

For example, in the case of a new user who wishes to perform monochrome printing, the new user can learn from the printer information of the printers P1, P2, and P3 in the sort results shown in FIGS. 9 and 10 that the printers P2 and P3 have histories of color printing but the printer P1 has only a history of monochrome printing. As a result, the new user can estimate that the printer P1 is a monochrome printer apparatus. Therefore, it is evident that a printer apparatus recommended for this new user to install is the printer P1.

As a structure of the internal database 14 shown in FIGS. 6, 7, and 8, the internal database 14 has various items such as cost per sheet at the time of printing of the printer apparatus, a present state including a state of jam of the printer apparatus and sheet shortage, the number of times of repair, a staple function, a last maintenance day, information for specifying an application program on the side of the client PC that executes printing, and an indication on whether the printer apparatus is a default printer, and they can be selected according to the purpose for which the user wishes to use as a key for obtaining sort results shown in FIGS. 9 and 10.

When the client PC of the new user is connected to the network or installation of a printer driver or the like is performed by the new user, new information is added to the internal database 14 and the internal database 14 is updated concerning the selection information including the peculiar information stored in the internal database 14 such as IP addresses and machine names of client PCs that request searches, date and times printer apparatuses are searched for, indications on whether printer drivers are finally installed, and printing modes such as color or monochrome of printing executed when the printer drivers are installed.

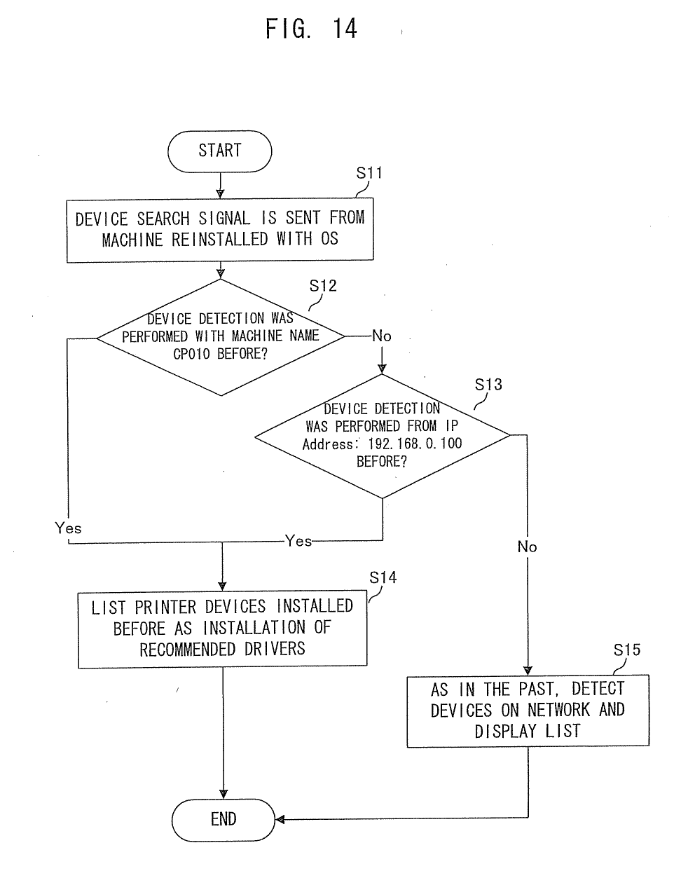

FIGS. 11, 12, and 13 are explanatory diagrams showing contents of the internal database 14 at the time when a new user installs a printer driver for the printer P3. FIG. 11 shows contents of the internal database 14 concerning the printer P1 and FIG. 12 shows contents of the internal database 14 concerning the printer P2. New selection information indicating that a new user of the IP address 192.168.0.111 has searched for the printers P1 and P2 from the client PC having the machine name PC011 but has not executed installation of a printer driver is added to the internal database 14 and the internal database 14 is updated. FIG. 13 is an explanatory diagram showing contents of the internal database 14 concerning the printer P3. New selection information indicating that the new user of the IP address 192.168.0.111 has searched for the printers P1 and P2 from the client PC having the machine name PC011, executed installation of the printer driver, and performed color printing is added to the internal database 14 and the internal database 14 is updated.

As a result, when a different user additionally uses a printer apparatus next time, it is possible to provide this user with selection information concerning the printer apparatus additionally used by the user. The user can acquire selection information indicating a present state on the network concerning this new printer apparatus additionally used by sorting the selection information with, for example, a last printing day or the number of times of installation as a key.

As described above, according to this embodiment, it is possible to provide an environment in which a new user can easily and efficiently determine which printer driver should be installed according to frequencies of use of printer apparatuses on a network (or the same is possible for each domain, department, or floor).

Another embodiment of the printer management apparatus and the printer management method will be explained. In this embodiment, it is assumed that FIGS. 1 to 4, FIGS. 5 to 8, and FIGS. 11 to 13 are applied again and structures of the respective internal databases of the printer apparatuses P1, P2, and P3 have the contents shown in FIGS. 11 to 13.

In this embodiment, when reinstallation of an OS is executed in a client PC of a user and a printer driver is reset, work required for installation of the printer drive at the time of the reinstallation of the OS is smoothed and simplified by allowing the user to search for a printer apparatus installed before the reinstallation of the OS.

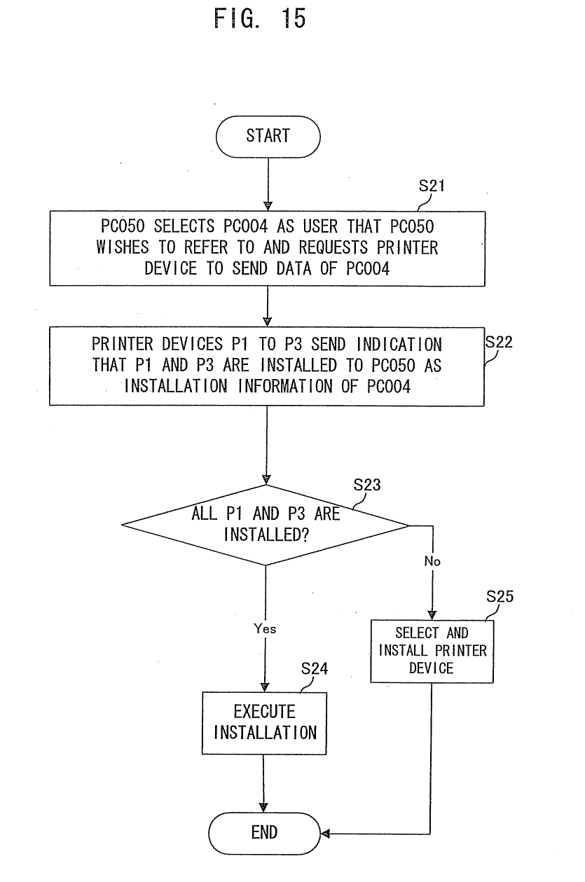

Operations of the printer management apparatus and the printer management method according to this embodiment will be hereinafter explained. FIG. 14 is a flowchart showing operations of the printer management apparatus and the printer management method of this another embodiment. First, in step S1, a signal for device detection is outputted from the client PC reinstalled with the OS to this network. It is possible to send the signal for device detection to respective printer apparatuses on the network in a form of multicast in the same manner as the embodiment described above. In step S12, a machine name of the client PC, which sends the signal for device detection is checked and it is checked from the history of selection information stored in the internal database 14 shown in FIG. 1 whether device detection was performed with the same machine name in the past. In an example of step S12, it is determined whether device detection was performed with the machine name PC010 before. As a result, when it is determined that device detection was not performed with the machine name PC010, processing proceeds to step S13. In step S13, it is determined from the history of selection information stored in the internal database 14 whether device detection was performed from an IP address before. In an example in step S13, it is determined whether device detection was performed from the IP address 192.168.0.100, i.e., an IP address allocated to the client PC having the machine name PC010.

As a result, when it is determined that there is an installation history indicating that device detection was performed from the machine name in step S12 or the IP address in step S13, in step S14, installation of a printer driver that the client PC reinstalled with the OS has installed is recommended to the client PC and the printer driver is displayed on the client PC. In this case, automatic installation of the printer driver may be executed in the client PC reinstalled with the OS. Therefore, in the client PC reinstalled with the OS, when plural printer drivers were installed before the reinstallation of the OS, all printer drivers on the network installed are displayed as a list. In the constitution described above, steps S13 and S14 constitute a specific-user-state searching unit, specific-user-state searching means, and a specific-user-state searching step in the embodiment of the invention.

When it is determined in step S12 that device detection was not performed with the machine name PC010 and it is determined in step S13 that device detection was not performed from the IP address allocated to the client PC having the machine name PC010, in step S15, a response is returned to the client PC reinstalled with the OS. As in the past, detection of the printers on the network and a list of the printers are displayed on the client PC reinstalled with the OS.

In the above explanation, it is possible to search for printer drivers for all the printers on the network installed before reinstallation of the OS on the basis of a machine name or an IP address. However, the search is not based on only the machine name or the IP address and may be based on any peculiar information including a user name as long as an [individual] client PC can be specified.

As described above, according to this embodiment, when the OS is reinstalled in the client PC and the printer is reset, before reinstallation of the OS, the user is capable of searching for a printer driver installed in the client PC used by the user. Thus, it is possible to smoothly and quickly establish an environment for the printer when the OS is reinstalled.

Still another embodiment of the printer management apparatus and the printer management method will be explained. In this embodiment, it is assumed that FIGS. 1 to 4, FIGS. 5 to 8, and FIGS. 11 to 13 are applied again and structures of the internal database 14 of the printer P1, P2, and P3 have the contents shown in FIGS. 11 to 13.

In this embodiment, it is possible to refer to a state of installation of a printer driver by a specific user on a network, install a printer driver same as that of the specific user, and use a printer same as a printer used by the specific user.

FIG. 15 is a flowchart showing operations of the printer management apparatus and the printer management method according to this another embodiment. In an explanation referring to the flowchart in FIG. 15, as an example, when a new user of a client PC having a machine name PC050 and an IP address 192.168.0.250 makes connection to the network, the new user refers to an installation state of a printer driver by a user of a client PC having a machine name PC004.

First, in step S21, the new user of the client PC having the machine name PC050 selects a user of a client PC having a machine name PC004 as a user, who the new user wishes to refer to, and requests data indicating an installation state of a printer driver by the user of the client PC having the machine name PC004 via the network. In this case, rejection of reference may be set. In the following step S22, the client PC having the machine name PC004 searches for the data indicating the installation state of the printer driver by the user of the client PC having the machine name PC004 stored in the internal database 14 shown in FIG. 1 and sends a result of the search to the client PC having the machine name PC050. In this case, a search result indicating that installation of printer drivers for the printers P1 and P3 is performed is returned based on the contents of the internal database 14 shown in FIGS. 11 to 13. In the next step S23, the client PC having the machine name PC050 determines whether installation of the printer drivers for all the printers P1 and P3 should be executed. When installation of both the printer drivers is executed, in step S24, the client PC having the machine name PC050 executes installation of the printer drivers for both the printers P1 and P3. On the other hand, when it is determined that installation of the printer drivers for all the printers P1 and P3 is not executed, in step S25, installation of a selected printer driver is executed.

As described above, according to this embodiment, it is possible to efficiently select a printer driver to be installed by referring to installation states of printer drivers of other users.

Some users may reject reference to installation states of printer drivers. Thus, in this case, disallowance of reference can be set. In this case, it is possible to hold data not to be referred to as an installation history on a printer side.

When a printer driver is not only installed but also selected from a printer at the time of printing, it is possible to select which printer is suitable for use (or recommend a printer from the printer side) according to contents (color or monochrome, 2 in 1, staple, etc.) set in the printer driver.

It is also possible to apply the state-of-use managing means, the state-of-use displaying means, and the specific-user-state searching means explained in the embodiments to a program that causes a computer to execute the printer management method explained according to the flowcharts described in the embodiments. This program has a function of being recorded in a computer-readable recording medium, read by the computer, and causing the computer to execute the printer management method of the invention. Concerning such a function, in the explanation of the embodiments, the function of carrying out the invention is recorded in the apparatus in advance. However, the invention is not limited to this. The same function may be downloaded to the apparatus from a network or the same function stored in a recording medium may be installed in the apparatus. A form of the recording medium may be any form as long as the recording medium is a recording medium that can store a program and is readable by the apparatus such as a CD-ROM. The function obtained by installation and download in this way may be realized in cooperation with an OS (operating system) or the like in the apparatus.

In the respective embodiments described above, the invention is explained in detail using the specific forms. However, it would be apparent for those skilled in the art that various alterations and modifications can be made without departing from the sprit and the scope of the invention.

What is claimed is:

1. A printer management apparatus comprising:
a state-of-use managing unit configured to manage, on the basis of a history of communication with a terminal apparatus, predetermined information concerning a state of use of a printer by the terminal apparatus; and
a state-of-use displaying unit configured to transmit, in response to a printer device detection signal received from the terminal apparatus, the predetermined information concerning the state of use of the printer managed by the state-of-use managing unit to the terminal apparatus, which transmits the printer device detection signal, and cause the terminal apparatus to display the predetermined information.

2. A printer management apparatus according to claim 1, wherein the predetermined information concerning the state of use of the printer is a number of times of execution of installation of a printer driver in the terminal apparatus for the printer.

3. A printer management apparatus according to claim 1, wherein the predetermined information concerning the state of use of the printer is a last printing day in the printer at the time when installation of a printer driver in the terminal apparatus for the printer is executed.

4. A printer management apparatus according to claim 1, wherein the predetermined information concerning the state of use of the printer is a printing mode such as color printing or monochrome printing in the printer at the time when installation of a printer driver in the terminal apparatus for the printer is executed.

5. A printer management apparatus according to claim 1, wherein the printer management apparatus is constituted in a multifunction peripheral including a printing apparatus, a scanning apparatus, a control panel, a database, a control unit, and a system bus.

6. A printer management apparatus according to claim 1, wherein
the state-of-use managing unit manages, on the basis of a history of communication with a terminal apparatus, predetermined information concerning states of use of plural printers by the terminal apparatus,
the state-of-use displaying unit transmits, in response to a printer device detection signal received from the terminal apparatus, the predetermined information concerning the state of use of the plural printers managed by the state-of-use managing unit to the terminal apparatus, which transmits the printer device detection signal, and causes the terminal apparatus to display the predetermined information.

7. A printer management apparatus according to claim 1, wherein the state-of-use displaying unit transmits, in response to a printer device detection signal received from a terminal apparatus reinstalled with an OS, predetermined information concerning a state of use of a printer before the reinstallation of the OS in the terminal apparatus managed by the state-of-use managing unit to the terminal apparatus, which transmits the printer device detection signal, and causes the terminal apparatus to display the predetermined information.

8. A printer management apparatus according to claim 1, comprising a specific-user state-of-use searching unit configured to search for, when a request for predetermined information concerning a state of use of a printer managed by the state-of-use managing unit for another specific terminal is received from a terminal apparatus, the predetermined information concerning the state of use of the printer for the another specific terminal apparatus and transmit a result of the search to the terminal apparatus.

9. A printer management apparatus comprising:
state-of-use managing means for managing, on the basis of a history of communication with a terminal apparatus, predetermined information concerning a state of use of a printer by the terminal apparatus; and
state-of-use displaying means for transmitting, in response to a printer device detection signal received from the terminal apparatus, the predetermined information concerning the state of use of the printer managed by the state-of-use managing means to the terminal apparatus, which transmits the printer device detection signal, and causing the terminal apparatus to display the predetermined information.

10. A printer management apparatus according to claim 9, wherein the predetermined information concerning the state of use of the printer is a number of times of execution of installation of a printer driver in the terminal apparatus for the printer.

11. A printer management apparatus according to claim 9, wherein the predetermined information concerning the state of use of the printer is a last printing day in the printer at the time when installation of a printer driver in the terminal apparatus for the printer is executed.

12. A printer management apparatus according to claim 9, wherein the predetermined information concerning the state of use of the printer is a printing mode such as color printing or monochrome printing in the printer at the time when installation of a printer driver in the terminal apparatus for the printer is executed.

13. A printer management apparatus according to claim 9, wherein the printer management apparatus is constituted in a multifunction peripheral including a printing apparatus, a scanning apparatus, a control panel, a database, a control unit, and a system bus.

14. A printer management apparatus according to claim 9, wherein
the state-of-use managing means manages, on the basis of a history of communication with a terminal apparatus, predetermined information concerning states of use of plural printers by the terminal apparatus,
the state-of-use displaying means transmits, in response to a printer device detection signal received from the terminal apparatus, the predetermined information concerning the state of use of the plural printers managed by the state-of-use managing means to the terminal apparatus, which transmits the printer device detection signal, and causes the terminal apparatus to display the predetermined information.

15. A printer management apparatus according to claim 9, wherein the state-of-use displaying means transmits, in response to a printer device detection signal received from a terminal apparatus reinstalled with an OS, predetermined information concerning a state of use of a printer before the reinstallation of the OS in the terminal apparatus managed by the state-of-use managing means to the terminal apparatus, which transmits the printer device detection signal, and causes the terminal apparatus to display the predetermined information.

16. A printer management apparatus according to claim 9, comprising specific-user state-of-use searching means for searching for, when a request for predetermined information concerning a state of use of a printer managed by the state-of-use managing means for another specific terminal is received from a terminal apparatus, the predetermined information concerning the state of use of the printer for the another specific terminal apparatus and transmitting a result of the search to the terminal apparatus.

17. A printer management method comprising the steps of:
managing, on the basis of a history of communication with a terminal apparatus, predetermined information concerning a state of use of a printer by the terminal apparatus in a state-of-use managing unit by databasing the predetermined information;
receiving a printer device detection signal of multicast transmitted from the terminal apparatus; and
a state-of-use displaying unit transmitting, in response to a printer device detection signal received, the predetermined information concerning the state of use of the printer managed by the state-of-use managing unit to the terminal apparatus, which transmits the printer device detection signal, and causing the terminal apparatus to display the predetermined information.

18. A printer management method according to claim 17, wherein the predetermined information concerning the state of use of the printer is a number of times of execution of installation of a printer driver in the terminal apparatus for the printer.

19. A printer management method according to claim 17, wherein the predetermined information concerning the state of use of the printer is a last printing day in the printer at the time when installation of a printer driver in the terminal apparatus for the printer is executed.

20. A printer management method according to claim 17, wherein the predetermined information concerning the state of use of the printer is a printing mode such as color printing or monochrome printing in the printer at the time when installation of a printer driver in the terminal apparatus for the printer is executed.
